(19) United States
(12) Patent Application Publication
(10) Pub. No.: US 2007/0296116 A1
(43) Pub. Date: Dec. 27, 2007

(54) PROCESS FOR MANUFACTURING A HYBRID ELECTRICAL COMPONENT

(76) Inventor: Hans-Georg Huonker, Villingen-Schwenningen (DE)

Correspondence Address: MCGLEW & TUTTLE, PC, P.O. BOX 9227, SCARBOROUGH STATION, SCARBOROUGH, NY, 10510-9227, US

(21) Appl. No.: 11/764,406

(22) Filed: Jun. 18, 2007

(30) Foreign Application Priority Data
Jun. 21, 2006 (DE) 10 2006 028 815.7

(51) Int. Cl. B29C 45/14

(52) U.S. Cl. 264/263; 264/272.11

(57) ABSTRACT

A process is provided for manufacturing a hybrid electrical component (40), which has as electrical conductors connection elements (2, 3, 4, 5). The electrical conductors connection elements are punched out of a pressed screen (1) and are in turn extrusion-coated with a plastic housing (24). To make it possible to manufacture such a hybrid component in a possibly continuous process, the connection elements (2, 3, 4, 5) are connected to one another at least before the extrusion coating with stabilizing webs (6, 7, 8, 9, 10, 11, 12, 13, 14, 15, 16) and are stationarily in connection with the pressed screen (1) via holding webs (17, 18, 19, 20). The pressed screen (1) is extrusion coated with a plastic housing (24) together with the connection elements (2, 3, 4, 5) that are in connection with the pressed screen (1) in one injection molding operation. At least two plastic bridges (36, 37, 38, 39), via which the injected plastic housing (24) is additionally connected to the pressed screen (1), are injected on the plastic housing (24).

### CROSS REFERENCE TO RELATED APPLICATIONS

This application claims the benefit of priority under 35 U.S.C. § 119 of German Patent Application DE 10 2006 028 815.7 filed Jun. 21, 2006, the entire contents of which are incorporated herein by reference.

### FIELD OF THE INVENTION

The present invention pertains to a process for manufacturing a hybrid electrical component, which has as electrical conductors connection elements punched out of a pressed screen, are already well known from the state of the art. These connection elements are embedded in an extrusion-coated plastic housing in the finished hybrid component. To prevent the connection elements from leaving their preset positions during the extrusion coating, these are stationarily connected, on the one hand, to one another via stabilizing webs, and, on the other hand, to the pressed screen via holding webs.

### BACKGROUND OF THE INVENTION

Processes for manufacturing hybrid electrical components, for example, in the form of electrical plug type components or plug type connections, are known, for example, from DE 10 2004 044 614.8. That document describes essentially the extrusion coating of hybrid components, which contain especially electronic components, which are to be extrusion coated.

A hybrid component is defined according to that document as a component that consists of different materials, especially metal and plastic. So-called pressed screens, which are manufactured from a strip-shaped sheet metal part, are used to manufacture such hybrid components. The electrical connection elements of the hybrid component, which remain connected to one another and to the rest of the sheet metal part via stabilizing webs and holding webs, so that the pressed screen proper is present thereafter, are manufactured from the strip-shaped sheet metal part by corresponding punching and bending operations. This means that the pressed screen is a sheet metal strip, which contains prepunched connection elements, which are later extrusion coated to form the finished hybrid component. Especially the manufacture of such a pressed screen with the stabilizing webs mentioned is described, for example, in DE 254 840 A1.

Furthermore, it is known from DE 10 2004 044 614.8 that the individual connection elements are integrated in the strip-shaped pressed screen after the punching operation, lying one after another. The punched connection elements are in connection with one another via stabilizing webs in order to be positioned with precision in relation to one another during the subsequent injection molding operation. Furthermore, the connection elements are stationarily connected to the pressed screen or the rest of the sheet metal strip after the punching.

These holding webs are cut before the injection molding operation in the state of the art, so that the connection elements, which are still connected to one another, are now separate individual parts. This individual part is now fed, for example, to a horizontal injection molding machine by means of a corresponding handling means and inserted there on the nozzle side of the machine. After closing the injection mold, the sheet metal part is extrusion coated with plastic, so that the connection elements are embedded in a plastic housing that is being formed and form the hybrid component together with same.

After the extrusion coating, the hybrid component with its plastic housing and with the connection elements, which are still in connection with one another, is again removed from the injection molding machine and fed to a cutting or punching means. This cutting or punching means has corresponding cutting tools, by means of which the stabilizing webs between the connection elements are cut by punching. This cutting operation is necessary to make it possible to subject the hybrid component or the connection elements thereof to a voltage testing in another process step. Another testing station, in which the hybrid component is tested for arcing, is provided for this purpose.

For example, a process in which the cut connection elements manufactured by punching are inserted with their stabilizing webs into an injection mold, is known from EP 1 170 110 A1. This means that the connection elements are also stationarily in connection with one another via the stabilizing webs before the injection molding to maintain their desired positions during the injection molding operation. The connection elements are cut from the strip-shaped pressed screen prior to the injection molding, so that these connection elements can be inserted into the injection mold. A hybrid component, comprising the connection elements and the plastic housing prepared during the extrusion coating, is thus formed by the subsequent extrusion coating. The stabilizing webs may be eliminated after the extrusion coating in this case as well, because the connection elements are held by the extrusion-coated plastic.

The manufacture of such a plug type electrical module or hybrid component is extremely complicated because of the process steps for manufacturing such modules or components, which were described above especially in connection with DE 10 2004 044 614.8. In particular, special handling means, for example, industrial robots, are also necessary for this to make it possible to transport the individual intermediate products from one work station to the next one.

### SUMMARY OF THE INVENTION

The basic object of the present invention is to provide a process for manufacturing a hybrid component, in which the individual manufacturing steps take place one after another in a continuous process.

According to the present invention a process is provided for manufacturing a hybrid electric component, which has connection elements as electric conductors. The connection elements are punched out of a pressed screen and are extrusion coated with a plastic housing. The connection elements are connected to one another with stabilizing webs at least before the extrusion coating and are stationarily in connection with the pressed screen via holding webs. The pressed screen is extrusion coated, together with the connection elements, which are in connection with the pressed screen, with a plastic housing in an injection molding operation. At least two plastic bridges, via which the injected plastic housing is additionally connected to the pressed screen, are injected on the plastic housing.

The process according to the present invention makes possible a continuous production process, in which the pressed screen with the connection elements can be fed to different manufacturing processes in consecutive process steps taking place continuously.

Provisions are made for this for the connection elements, which are in connection with one another, to remain on the pressed screen during the extrusion coating. Plastic bridges are now injected between the plastic housing and the pressed screen during the extrusion coating operation, so that there remains an additional connection between the pressed screen and the connection elements even after the cutting of the holding webs. The plastic housing and the connection elements embedded therein can thus be fed, together with the pressed screen to further process steps of the manufacturing process, without an industrial robot or the like being necessary.

Thus, provisions may be made for the plastic bridges to be injected in the area of the holding webs. It is ensured hereby that the plastic bridges are made integrally in one piece with the plastic housing of the hybrid component and an unintended cutting of the plastic bridges from the plastic housing of the hybrid component is ruled out with certainty.

According to another aspect of the invention provisions may, furthermore, be made for the pressed screen to be fed, together with the hybrid component comprising the connection elements and the plastic housing, to a cutting or punching means, and for the holding webs to be electrically separated by the cutting or punching means. It is ensured here by the plastic bridges provided between the pressed screen and the plastic housing of the hybrid component that the hybrid component remains reliably anchored on the pressed screen even after the cutting of the holding webs and thus it can be fed with the pressed screen to additional manufacturing processes after the cutting as well.

Furthermore, provisions may be made for the connection elements to be electrically separated from one another by the cutting or punching means by cutting the stabilizing webs. The hybrid component is now prepared hereby for a voltage testing, because its connection elements are also cut from one another electrically.

Some of the process steps mentioned may take place simultaneously, so that a separate manufacturing step of the cutting operations is eliminated.

Provisions may be made for the pressed screen to be fed together with the hybrid component to an electric voltage testing means, in which the hybrid component is tested for arcing. The hybrid component is transported together with the strip-shaped pressed screen during this manufacturing or process step as well, so that no industrial robots or the like are needed for this whatsoever, either.

In a last process step the hybrid component can be cut out of the pressed screen by another punching or cutting operation, for example, by shearing off the plastic bridges, so that the finished hybrid component is subsequently obtained. It is no longer necessary to feed the finished hybrid component, for example, for the electric voltage testing, because it had already happened before.

It can be recognized that the hybrid component remains in the punched screen due to the plastic bridges injected additionally and can thus be fed, in a continuous process, at first together with the pressed screen, to a cutting or punching means, by which the stabilizing webs between the connection elements, on the one hand, and the holding webs between the connection elements and the pressed screen, on the other hand, can be cut. Since the hybrid component thus manufactured continues to remain in the pressed screen via the plastic bridges, this pressed screen can be fed, together with the hybrid component, to a voltage testing means in another continuous process. After the conclusion of this voltage testing, only the plastic bridges are to be finally cut off as the last process step, so that the completely tested hybrid component is now obtained.

Based on the drawing, the process will be explained below in more detail on the basis of an exemplary embodiment of a hybrid component. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which the preferred embodiment of the invention is illustrated.

### BRIEF DESCRIPTION OF THE DRAWINGS

In the drawings:

FIG. 1 is a top view of a detail of a pressed screen with already completely punched and possibly bent connection elements, which are in connection with one another via stabilizing webs, on the one hand, and with the pressed screen via holding webs, on the other hand, as well as connection elements, which are already extrusion coated with a plastic housing and in which additional plastic bridges are provided in the area of the holding webs as a connection between the plastic housing and the pressed screen;

FIG. 2 is an enlarged detail II from FIG. 1 with the holding webs as a connection between the connection elements and the pressed screen and plastic bridges, which are additionally prepared by injection and by which the injected plastic housing is in connection with the pressed screen;

FIG. 3 is a bottom view of the connection from FIG. 2;

FIG. 4 is a partial sectional view IV-IV from FIG. 1 and FIG. 2, which shows the extrusion coated plastic body, on the one hand, and the injected plastic bridges, on the other hand; and

FIG. 5 is the view from FIG. 4 after cutting the stabilizing webs and the holding webs.

### DESCRIPTION OF THE PREFERRED EMBODIMENT

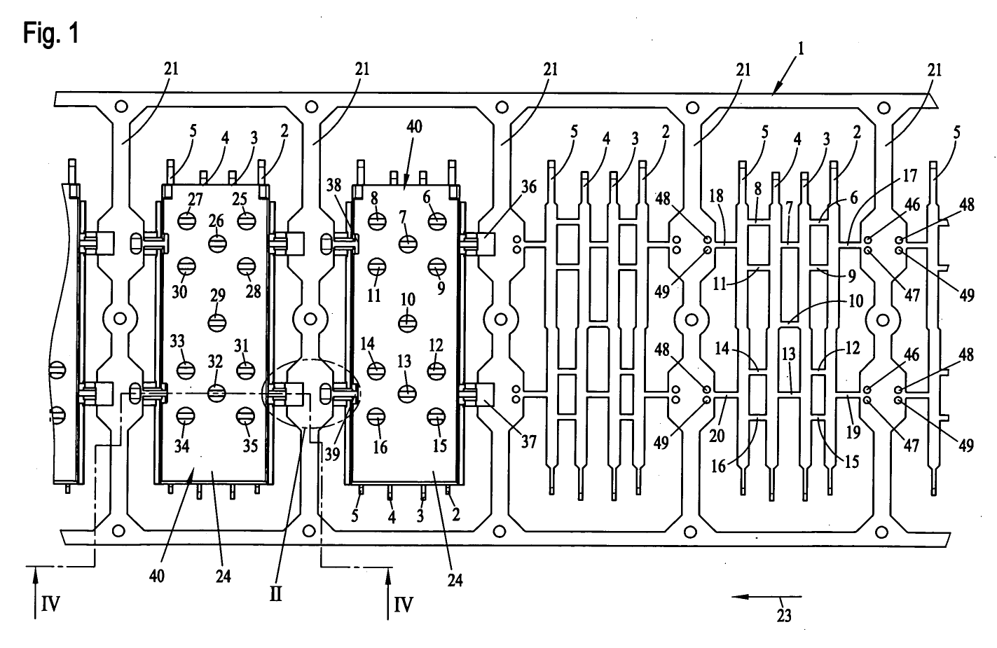

Referring to the drawings in particular, FIG. 1 shows a top view of a pressed screen 1, which is already prepunched or prebent. As is known from the state of the art, this pressed screen 1 is manufactured from a sheet metal part or sheet metal strip. A plurality of connection elements 2, 3, 4, 5, which are in connection with one another via a plurality of stabilizing webs 6, 7, 8, 9, 10, 11, 12, 13, 14, 15 and 16, are punched out of this sheet metal strip in a punching operation. This unit, comprising the connection elements 2 through 5 and the stabilizing webs 6 through 16, is in connection, for example, with transversely extending traverses 21 of the pressed screen 1 via a plurality of holding webs 17, 18, 19 and 20. The groups of connection elements 2 through 5 can thus be fed to different consecutive production processes in a continuous operation by transporting the pressed screen 1 in the direction of arrow 23.

The right-hand half of FIG. 1 shows two such groups of connection elements 2 through 5, which have an identical design and are also prepunched and possibly prebent to manufacture identical hybrid components.

The first process step, in which the pressed screen 1 is punched out and the connection elements 2 through 5 with their stabilizing webs 6 through 16 as well as with the holding webs 17 through 20 are prepared, is followed now by the extrusion coating of the connection elements 2 through 5 in an injection molding machine, which is not shown in more detail in the drawings. The pressed screen 1 with a group of connection elements 2 through 5 is transported now into the area of a corresponding injection mold cavity, in which a plastic housing 24 is injected around the connection elements 2 through 5, as this is shown as an example in FIG. 1 for the two left-hand groups of connection elements 2 through 5.

This plastic housing 24 surrounds the connection elements 2 through 5, and the stabilizing webs 6 through 16 are not extrusion-coated. As is apparent from FIG. 1, openings 25, 26, 27, 28, 29, 30, 31, 32, 33, 34 and 35 are left here, so that the stabilizing webs 6 through 16 can be punched out in a later process step in a punching or cutting operation. For the sake of clarity, the openings 25 through 35 in the left-hand plastic housing 24 and the corresponding stabilizing webs 6 through 16 in the right-hand plastic housing 24 of FIG. 1 are identified with the corresponding reference numbers.

Furthermore, it is seen in FIG. 1 that additional plastic bridges 36, 37, 38 and 39, which are provided with reference numbers in the right-hand plastic housing 24, are injected on the plastic housing 24 in the area of the holding webs 17 through 20. The plastic bridges 36 and 37 and the plastic bridges 38 and 39 are of an identical design. All plastic bridges 36 through 39 may also be of identical design, and the embodiments being shown here should be considered to be examples only.

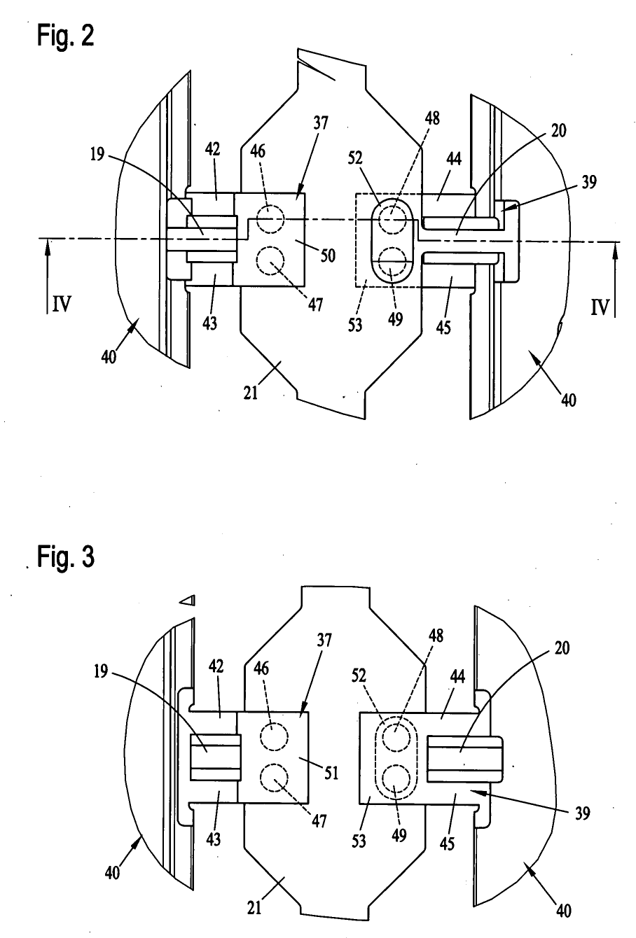

FIG. 2 shows for this an enlarged detail II from FIG. 1 with the two holding webs 19 and 20 as well as the plastic bridges 37 and 39 injected additionally on the two plastic housings 24 of two adjacent hybrid components 40. It can be recognized that the plastic bridges 37 and 39 have two bridge sections 42 and 43 as well as 44 and 45, which extend in parallel to the respective holding web 19 and 20 and which are injected on the respective plastic housing 24, on the one hand, and lead to the traverse 21 of the pressed screen 1, which [said traverse] is arranged between the two hybrid components 40 and can likewise be recognized from FIG. 1.

In the area of the bridge sections 42 and 43 as well as 44 and 45 of the plastic bridges 37 and 39, the traverse 21 has two openings 46 and 47 as well as 48 and 49 (cf. FIG. 1), by which a stationary connection can be established between the plastic bridges 37 and 39 and the two adjacent traverses 21.

FIG. 3 shows a bottom view of the connection from FIG. 2. On the one hand, it can be recognized from FIG. 2 that the left-hand plastic bridge 37 has a top-side holding plate 50 in the area of the traverse 21. As can be seen in FIG. 3, a second holding plate 51 is associated with the holding plate 50 on the underside, as is apparent from FIG. 3, and the two holding plates are in connection with one another via the corresponding openings 46 and 47. It is thus recognizable that the hybrid component 40 is stationarily connected to the traverse 21 via the plastic bridge 37 and the two holding plates 50 and 51 thereof via the correspondingly associated bridge sections 42 and 43.

The embodiment of the second plastic bridge 39 is slightly modified compared to the holding bridge 37. Thus, only one plastic plate 52, which is not directly in connection with the two bridge sections 44 and 45, is injected on the top side in the area of the two openings 48 and 49. This plastic plate 52 is of an oval shape in this exemplary embodiment and covers the two openings 48 and 49. As is apparent from FIG. 3, a holding plate 53, which covers the two openings 48 and 49, is likewise injected on the two bridge sections 44 and 45 on the underside. The plastic plate 52 is connected here by the two openings 48 and 49 to the holding plate 53, so that the holding plate 53 is stationarily in connection with the traverse 21.

The two plastic bridges 36 and 38 from FIG. 1 have the same design as the plastic bridges 37 and 39 described in FIGS. 2 and 3.

Provisions are made according to the present invention for both the stabilizing webs 6 through 16 (FIG. 1) and the holding webs 17 through 20 to be cut, for example, in a punching device after the plastic bridges 36, 37, 38 and 39 have been injected on the plastic housing 24. The electric connections between the connection elements 2 through 5, on the one hand, and those between the connection elements 2 through 5 and the adjacent traverses 21, on the other hand, are thus also electrically separated. The hybrid component 40 with its connection elements 2 through 5 can now be fed, together with the pressed screen 1, into a voltage testing means.

After the voltage testing has been performed, the hybrid components 40 can be cut out of the pressed screen 1 by cutting the plastic bridges 36, 37, 38 and 39, so that the finished hybrid component 40 is now obtained.

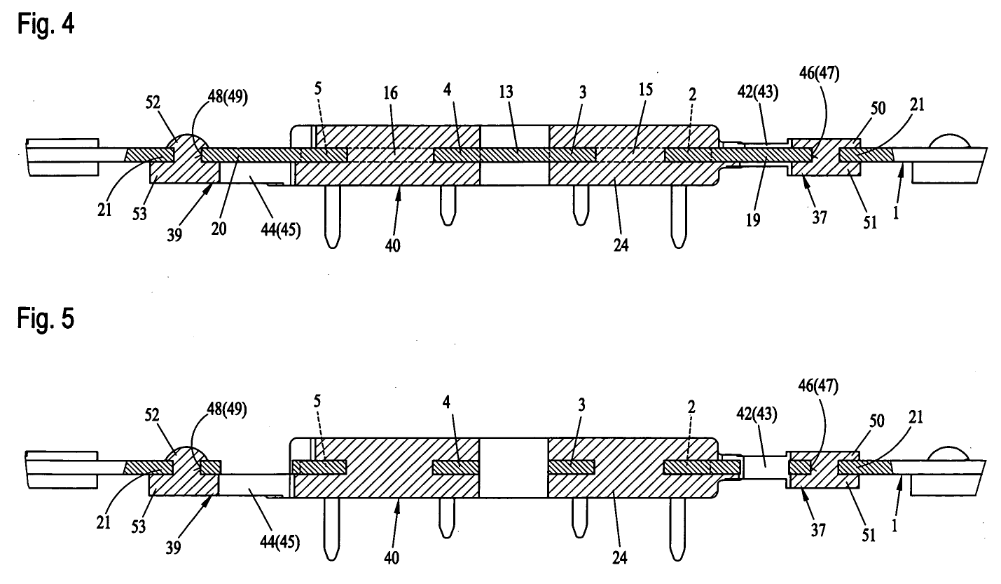

FIG. 4 shows a vertical section through the left-hand hybrid component 40 from FIG. 1 along the cutting line IV-IV, the cut extending exactly through the two plastic bridges 37 and 39 along the section line IV-IV from FIG. 2. Furthermore, FIG. 4 shows the four connection elements 2, 3, 4 and 5, which are stationarily in connection with one another, among other things, via the stabilizing webs 13, 15 and 16. The connection of the two outer connection elements 2 and 5 via the two holding webs 19 and 20 to the respective adjacent traverse 21 of the pressed screen 1 is also recognizable. The plastic housing 24 of the hybrid component 40 is in connection via the two bridge sections 42 and 43 with the holding plate 51 of the plastic bridge 37, which is in turn arranged approximately in the plane of the pressed screen 1 or the traverse 21. The plastic plate 50, which is in turn connected stationarily to the holding plate 51, is arranged on the top side in the area of the traverse 21 and the openings 46 and 47 thereof. The bridge sections 42 and 43 are arranged in the plane of the pressed screen 1 in this exemplary embodiment.

Furthermore, as is apparent from FIGS. 2 and 3, the two bridge sections 42 and 43 are arranged laterally next to the corresponding holding web 19. The holding web 19 can thus be punched out by a corresponding punching tool in a simple manner from bottom to top, so that the connection between the connection element 2 and the pressed screen 1 or the traverse 21 thereof is eliminated. The holding web 20 as well as the stabilizing webs 13, 15 and 16 as well as the other holding webs 17 and 18 and stabilizing webs 6 through 12 and 14, which are not recognizable in FIG. 4, can also be punched out at the same time in the same manner during the punching out of the holding web 19.

Furthermore, FIG. 4 shows that the plastic bridge 39 with its holding plate 53 and its plastic plate 52 is fixed on the left-hand side at the second traverse 21 of the pressed screen 1. It can also be recognized that the holding plates 53 and the plastic plate 52 are connected to one another in one piece by the openings 48 and 49.

The two bridge sections 44 and 45 connect the holding plate 53 to the plastic housing 24 of the hybrid component 40. FIG. 4 also shows that the two bridge sections 44 and 45 are arranged under the pressed screen 1 extending in the same horizontal plane in parallel to the holding web 20. These two bridge sections 44 and 45 are located at laterally spaced locations each from the holding web 20, as this can be recognized from FIGS. 2 and 3. This means that the holding web 20 is accessible from below by means of a corresponding punching tool in a simple manner during the subsequent punching operation for cutting the holding web 20.

FIG. 5 shows the view from FIG. 4 after the punching operation. It can be recognized that the holding webs 19 and 20 shown in FIG. 4 are removed in the area of the bridge sections 42 and 43 as well as 44 and 45. Furthermore, the stabilizing webs 13, 15 and 16 from FIG. 4 have been removed as well. The four connection elements 2, 3, 4 and 5 are thus cut from one another by this process step and are at the same time also cut from the adjacent traverses 21 of the pressed screen 1.

The hybrid component 40 with its plastic housing 24 and the connection elements 2 through 5 embedded therein can thus be fed to a subsequent voltage testing. Since the hybrid components 40 continue to be stationarily embedded in the pressed screen 1 due to the plastic bridges 36 through 39, this feed to a voltage testing means may, furthermore, also take place in a continuous operation, without a handling means in the form of, for example, an industrial robot, being necessary. Once this voltage testing has been completed, the plastic bridges 36, 37, 38 and 39 can be cut off, for example, by another punching operation, so that the hybrid component 40 is obtained in its final manufactured state as a separate and ready-to-use component.

It can be recognized that all the subsequent operations concerning the hybrid component 40 can be carried out in a continuous work process by the described manufacturing process with the injection of the plastic bridges 36 through 39 to the plastic housing 24, because the hybrid components 40 can be fed to the particular, consecutive machines by a continuous transport via the pressed screen 1.

In particular, the voltage testing of the individual connection elements 2, 3, 4, 5 or of the hybrid component 40 can likewise be carried out in a continuous work process, because the hybrid components 40 remain in the pressed screen 1 through the plastic bridges 36 through 39. In particular, a handling means, especially in the form of an industrial robot for supplying the cutting or punching means for cutting the stabilizing webs or for supplying the voltage testing means can thus be eliminated, so that the manufacturing process is considerably simplified and it thus becomes cost-favorable.

It is not absolutely necessary to arrange the additional plastic bridges in the area of the holding webs. Such plastic bridges may also be provided elsewhere and also in another number. It only must be guaranteed that the hybrid component with its housing remains stationarily in the pressed screen, so that the latter can be fed in a strip-shaped manner with the hybrid components to the individual machines.

While a specific embodiment of the invention has been shown and described in detail to illustrate the application of the principles of the invention, it will be understood that the invention may be embodied otherwise without departing from such principles.

What is claimed is:

1. A process for manufacturing a hybrid electric component, the process comprising:
punching out electric conductors said connection elements of a pressed screen wherein said connection elements are connected to one another with stabilizing webs at least before the extrusion coating and are stationarily in connection with said pressed screen via holding webs;
in an injection molding operation extrusion coating the punched out electric conductors said connection elements to provide a plastic housing, wherein said pressed screen is extrusion coated, together with said connection elements, which are in connection with said pressed screen; and
injecting at least two plastic bridges, via which said injected plastic housing is additionally connected to said pressed screen, on said plastic housing.

2. A process in accordance with claim 1, wherein said plastic bridges are injected in the area of said holding webs.

3. A process in accordance with claim 1, wherein:
said pressed screen is fed to a cutting or punching means together with said hybrid component comprising said connection elements and said plastic housing; and
said holding webs are electrically separated by the cutting or punching means.

4. A process in accordance with claim 3, wherein said connection elements are electrically separated from one another by the cutting or punching means by cutting said stabilizing webs.

5. A process in accordance with claim 4, wherein the separation of said holding webs and of said stabilizing webs takes place simultaneously in one step.

6. A process in accordance with claim 5, wherein said pressed screen is fed together with said hybrid component to an electrical voltage testing means, in which said hybrid component is tested for arcing.

7. A process in accordance with claim 6, wherein said hybrid component is cut from said pressed screen after the voltage testing by cutting said plastic bridges.
